(19) United States
(12) Patent Application Publication
(10) Pub. No.: US 2020/0272969 A1
(43) Pub. Date: Aug. 27, 2020

(54) INFORMATION PROCESSING SYSTEM, INFORMATION PROCESSING DEVICE, INFORMATION PROCESSING METHOD, PROGRAM, AND RECORDING MEDIUM

(71) Applicant: NS Solutions Corporation, Tokyo (JP)

(72) Inventor: Eiichi YOSHIDA, Tokyo (JP)

(21) Appl. No.: 16/644,117

(22) PCT Filed: Aug. 20, 2018
(86) PCT No.: PCT/JP2018/030673

§ 371 Date: Mar. 3, 2020

(30) Foreign Application Priority Data
Sep. 8, 2017 (JP) 2017-173009

(51) Int. Cl. G06Q 10/06; G06K 9/00; G08B 5/22; G06Q 50/28; G06Q 30/02

(52) U.S. Cl. CPC G06Q 10/06316; G06K 9/00664; G06Q 30/0282; G06Q 50/28; G08B 5/22

(57) ABSTRACT

An information processing system includes an output controller configured to perform control of outputting attention information for calling attention to a worker when a predetermined condition determined in advance for work is satisfied.

### TECHNICAL FIELD

The present invention relates to an information processing system, an information processing device, an information processing method, a program, and a recording medium.

### BACKGROUND ART

Conventionally, when calling attention to workers in warehouse work, a method has been adopted in which a signboard is put up to call attention. Further, Patent Literature 1 discloses, as a technique to call attention, a picking system is disclosed that notifies, in a combination area for work of combining a plurality of types of items, combination information necessary for combination in association with a box held on a moving rack.

### CITATION LIST

### Patent Literature

Patent Literature 1: Japanese Patent No. 5760925

### SUMMARY OF INVENTION

### Technical Problem

However, there is a problem that it is difficult to know that what is indicated on a signboard or the like is for the attention corresponding to which product or work. Further, in the technique of Patent Literature 1, there is a problem that a special mechanism such as transfer to a dedicated rack is required, resulting in increased cost.

The present invention has been made in view of such problems, and an object of the present invention is to call attention about work at an appropriate timing with a simple configuration.

### Solution to Problem

Therefore, the present invention is an information processing system that includes an output controller configured to perform control of outputting attention information for calling attention to a worker when a predetermined condition determined in advance for work is satisfied.

### Advantageous Effects of Invention

According to the present invention, it is possible to call attention about work at an appropriate timing with a simple configuration.

### BRIEF DESCRIPTION OF DRAWINGS

FIG. 1 is an overall view of an information processing system.

FIG. 2 is a diagram illustrating an example of a hardware configuration of smart glasses and others.

FIG. 3 is a diagram illustrating an example of a hardware configuration of a server device.

FIG. 4 is a diagram illustrating an example of a data configuration of a product table.

FIG. 5 is a diagram illustrating an example of a data configuration of an attention table.

FIG. 6 is a diagram illustrating an example of a data configuration of a worker table.

FIG. 7 is a diagram illustrating an example of a data configuration of a location table.

FIG. 8 is a sequence diagram illustrating a work management process.

FIG. 9 is a diagram illustrating an example of a data configuration of a pick list.

FIG. 10 illustrates an example of a display screen.

FIG. 11 illustrates an example of a display screen.

FIG. 12 illustrates an example of a display screen according to a modification.

FIG. 13 illustrates an example of a display screen according to a modification.

FIG. 14 illustrates an example of a display screen according to a modification.

FIG. 15 illustrates an example of display screen according to a modification.

FIG. 16 is a diagram illustrating an example of a data configuration of a table according to a modification.

### DESCRIPTION OF EMBODIMENTS

Hereinafter, embodiments of the present invention will be described with reference to the drawings.

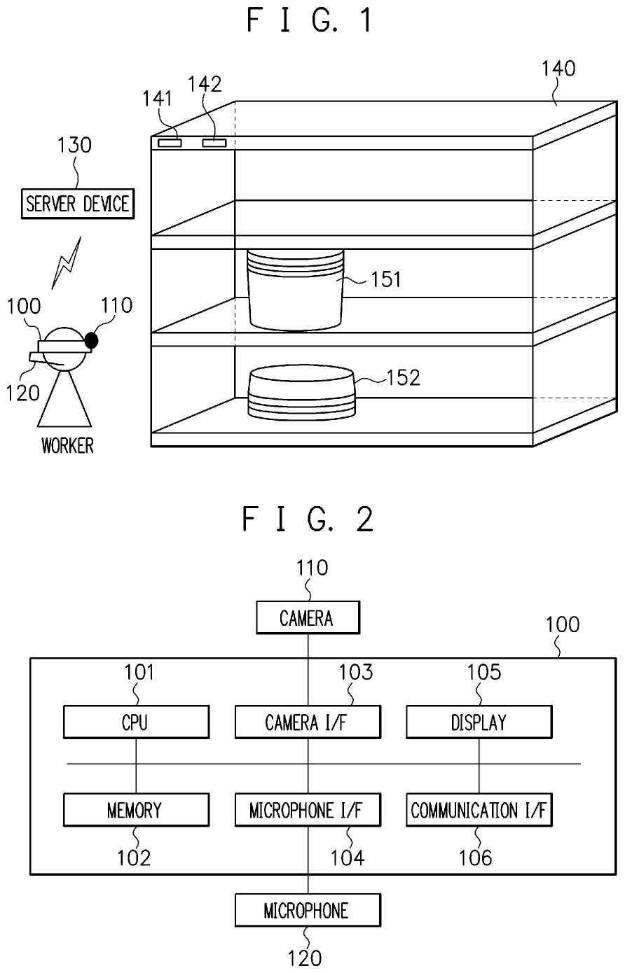

FIG. 1 is an overall view of an information processing system. The information processing system is a system for supporting a work performed by a worker, and includes a single or a plurality of smart glasses 100 and a server device 130. Here, the smart glasses 100 are an example of a wearable device. Here, examples of the work include picking work of items, storing work of items, putting-in-order work by rearranging items, and the like. It is noted that the work place is a warehouse. Here, the warehouse is a facility used for storing items. The storage of items includes, for example, temporary storage of items such as storage of items until the items are delivered after an order is received, temporary storage of intermediate products produced in factories, and long-term storage of items such as preservation and savings of resources. The smart glasses 100 and the server device 130 are connected via a network so that wireless communication is possible.

The smart glasses 100 are a glasses-type information processing device worn by a worker, and is connected to a camera 110 and a microphone 120. It is noted that, as another example, the smart glasses 100, the camera 110, and the microphone 120 may be configured as one device, or may be configured as separate devices communicably connected via a wired or wireless connection. Further, the device carried by the worker is not limited to the smart glasses 100, but may be a mobile terminal device such as a smartphone or a tablet.

The server device 130 is an information processing device that issues an instruction such as picking to the smart glasses 100. The server device 130 includes, for example, a personal computer (PC), a tablet device, a server device, and the like.

The worker works while wearing the smart glasses 100. In the present embodiment, an embodiment will be described as an example in which the worker picks a plurality of items according to a pick list. As illustrated in FIG. 1, products which are to be assembled from a body 151 and a lid 152 are stored in a rack 140 in which items are stored. It is noted that a plurality of bodies 151 and a plurality of lids 152 are stored in a state where the bodies 151 are stacked and the lids 152 are stacked. Further, the rack 140 illustrated in FIG. 1 displays a two-dimensional code 141 that indicates location information of the rack 140 and a two-dimensional code 142 that indicates a product code of a product (item) stored in the rack. The smart glasses 100 can identify the location where the worker is present from a captured image of the two-dimensional code 141. The smart glasses 100 can also identify a product from a captured image of the two-dimensional code 142. Here, the product code is information for identifying a product. The location information is information indicating a position and an area.

It is noted that any configuration and the like may be used as long as it has a mechanism for the smart glasses 100 to identify the location information of the worker and the product code from the captured image, and is not limited to the embodiment. As another example, a bar code, a color bit, or the like is displayed instead of the two-dimensional code, and the smart glasses 100 may identify the location or the like from their captured image. Further, as still another example, the location information and the product code may be displayed as text information on the rack. In this case, the smart glasses 100 may identify the location information or the like by performing a character recognition process on the captured image. Further, as yet another example, the location information or the like displayed on the rack 140 may be read out by the worker, and the smart glasses 100 may identify the location information or the like from the utterance of the worker.

FIG. 2 is a diagram illustrating an example of a hardware configuration of the smart glasses 100 and others. The smart glasses 100 include a CPU 101, a memory 102, a camera I/F 103, a microphone I/F 104, a display 105, and a communication I/F 106. These components are connected via a bus or the like. However, a part or all of the components may be configured as separate devices communicably connected via a wired or wireless connection.

The CPU 101 controls the entire smart glasses 100. The functions and processing of the smart glasses 100 are realized by the CPU 101 executing a process based on a program stored in the memory 102. The memory 102 stores the program, data used when the CPU 101 executes the process based on the program, and the like. The program may be stored, for example, on a non-transitory recording medium, and read into the memory 102 via an input/output I/F. The camera I/F 103 is an interface for connecting the smart glasses 100 and the camera 110. The microphone I/F 104 is an interface for connecting the smart glasses 100 and the microphone 120. The display 105 is a display unit of the smart glasses 100 including a display for realizing AR (Augmented Reality) or the like. The communication I/F 106 is an interface for communicating with another device, for example, the server device 130, via a wired or wireless connection.

The camera 110 performs image capturing based on a request from the smart glasses 100. The microphone 120 inputs a worker's voice as voice data to the smart glasses 100 or outputs a voice in response to a request from the smart glasses 100.

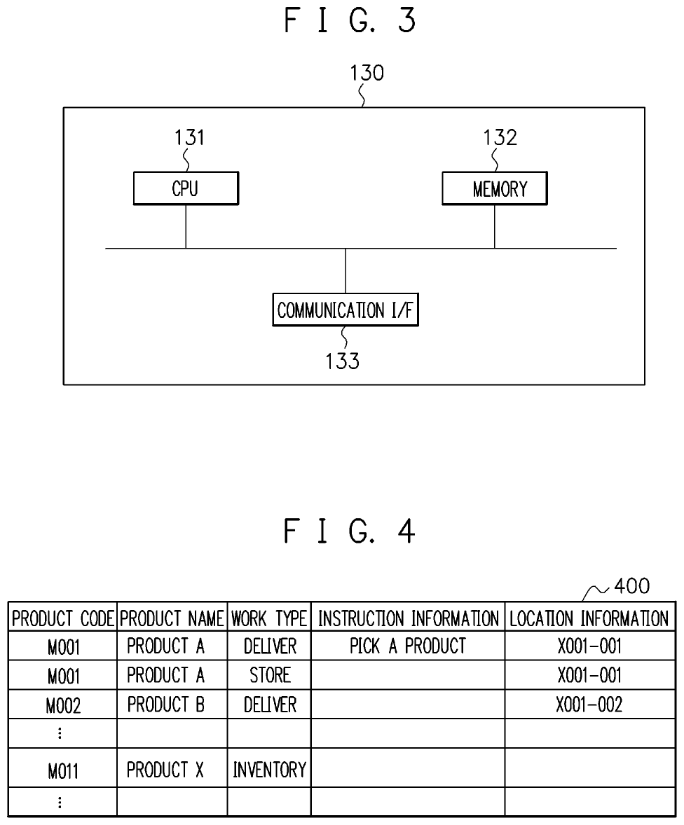

FIG. 3 is a diagram illustrating an example of a hardware configuration of the server device 130. The server device 130 includes a CPU 131, a memory 132, and a communication I/F 133. These components are connected via a bus or the like. The CPU 131 controls the entire server device 130. The functions and processing of the server device 130 are realized by the CPU 131 executing a process based on a program stored in the memory 132. The memory 132 is a storage unit of the server device 130 that stores a program, data used when the CPU 131 executes the process based on the program, and the like. The program may be stored, for example, on a non-transitory recording medium, and read into the memory 132 via the input/output I/F. The communication I/F 133 is an interface for communicating with another device, for example, the smart glasses 100, via a wired or wireless connection.

Next, information stored in the server device 130 will be described. The server device 130 stores a product table, an attention table, a worker table, and a location table. Each table will be described below. It is noted that the configuration of each table is an example, and various changes are possible in accordance with the specifications.

FIG. 4 is a diagram illustrating an example of a data configuration of a product table 400. In the product table 400, a product code, a product name, a work type, instruction information, and location information are associated with each other. The product code is identification information of a product. The work type is the type of work to be performed on the product. The instruction information is information indicating details of an instruction to be presented to a worker during the work. The location information is information indicating a place where the product is stored. In the present embodiment, the location information indicates areas in stages, such as a large area and a small area. For example, “X001-001” indicates a small area of “001” in a large area of “X001”. The location information may simply indicate “X001”. Further, the number of stages for areas is not limited to the embodiment. Further, the location information may include any information as long as it can identify a position, and its specific contents are not limited to the embodiment.

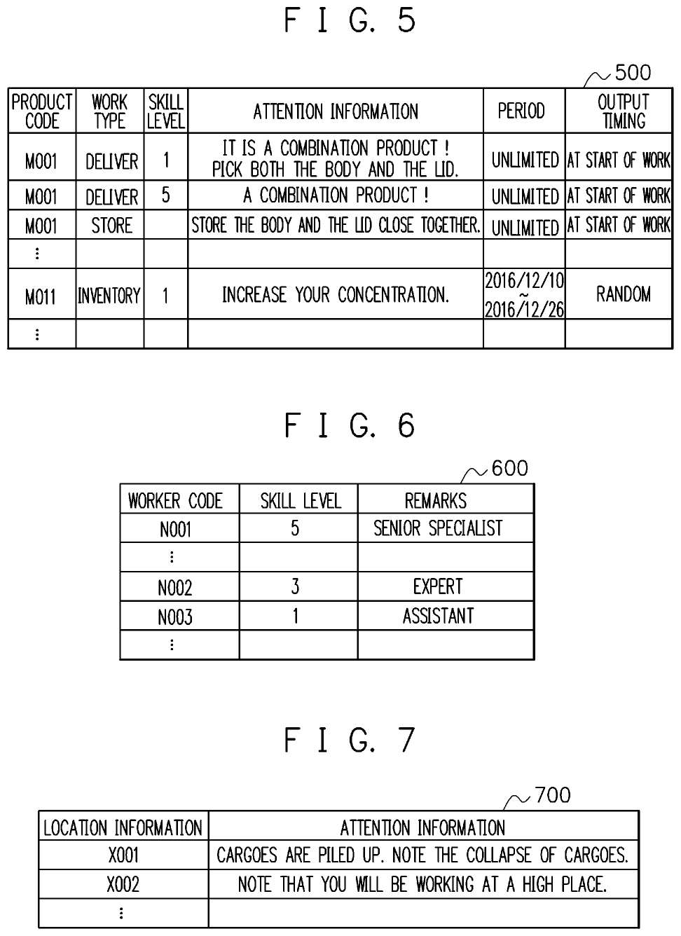

FIG. 5 is a diagram illustrating an example of a data configuration of an attention table 500. In the attention table 500, a product code, a work type, a skill level, attention information, a period, and an output timing are associated with each other. The skill level is information indicating the skill level of the worker required for the work. The attention information is information for calling attention to the worker in the corresponding work. The period is information indicating a period in which attention is required to be called. The output timing is information indicating a timing at which the attention information is output. As described above, the attention table 500 is a table that stores the attention information according to the product, the work type, and the skill level of the worker. Here, the product, the work type, and the skill level are predetermined conditions for determining whether or not to output the attention information.

FIG. 6 is a diagram illustrating an example of a data configuration of a worker table 600. In the worker table 600, a worker code, a skill level, and a remark are associated with each other. The worker code is identification information of a worker. FIG. 7 is a diagram illustrating an example of a data configuration of a location table 700. In the location table 700, location information and attention information are associated with each other. In other words, the location table 700 is a table that stores attention information depending on work places.

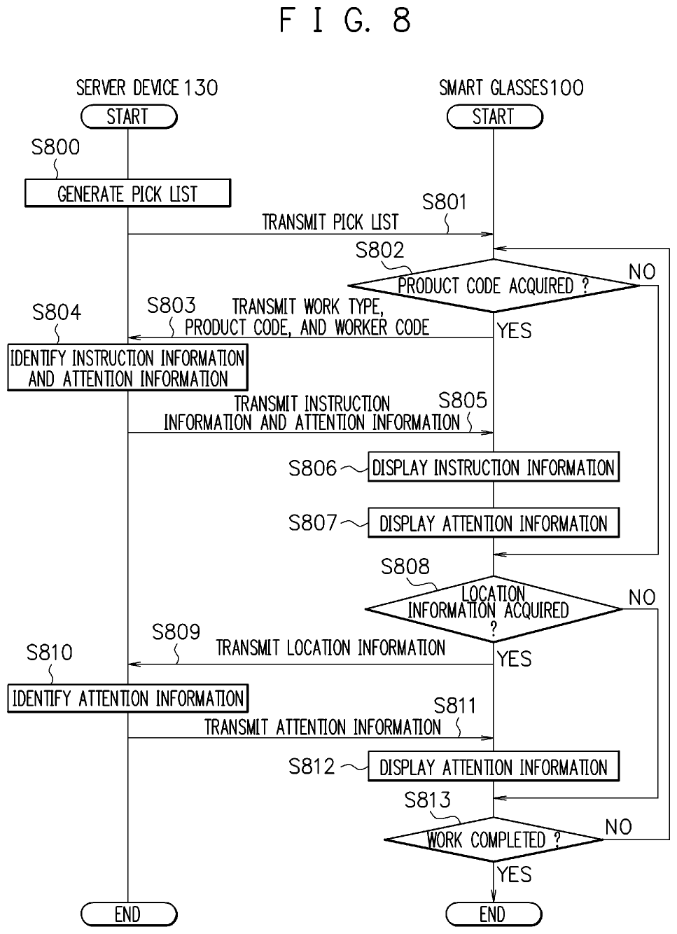

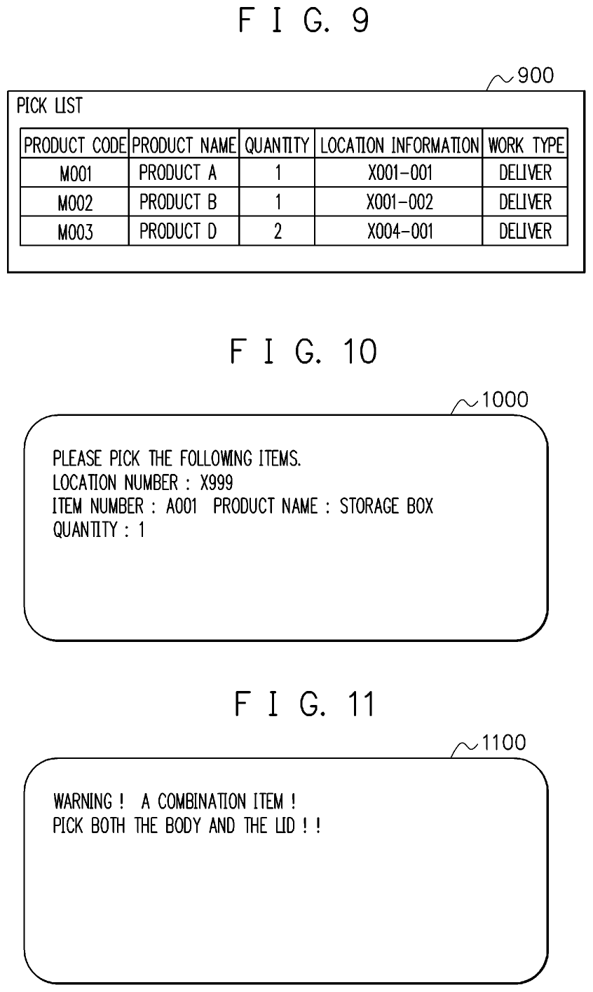

FIG. 8 is a sequence diagram illustrating a work management process performed by the information processing system. In S800, the CPU 131 of the server device 130 generates a pick list. Next, in S801, the CPU 131 transmits the pick list to the smart glasses 100 of a worker who performs work in accordance with the pick list. FIG. 9 is a diagram illustrating an example of a data configuration of a pick list 900. In the pick list 900, product codes of products to be picked are listed in the order of picking. Further, a product name, quantity, location information, and a work type are described in association with a product code. The pick list 900 is generated by the CPU 131 extracting necessary items from the product table 400 illustrated in FIG. 4 for a product to be delivered at the delivery work date and time stored in, for example, a delivery information table (not illustrated), in delivery work.

The worker carries out picking work in accordance with the pick list received by the smart glasses 100 worn by the worker. Specifically, the worker first moves to the rack for a product to be picked indicated in the pick list. It is noted that during the work of the worker, the camera 110 always captures images. Then, in S802, the CPU 101 of the smart glasses 100 determines whether or not a product code has been acquired. When a two-dimensional code is included in a captured image acquired from the camera 110 serving as an image capturing unit and the product code is read from the two-dimensional code, the CPU 101 determines that the product code has been acquired. As described with reference to FIG. 1, in the present embodiment, the two-dimensional code of the product code is displayed on the rack where the product is stored. Therefore, when the worker arrives at the rack for the product, the CPU 101 acquires the product code.

When the CPU 101 acquires the product code (Yes in S802), the processing proceeds to S803. If the CPU 101 fails to acquire a product code (No in S802), the processing proceeds to S808. In S803, the CPU 101 identifies the type of work associated with the product code acquired in S802 in the pick list. Then, the CPU 101 transmits the product code acquired in S802, the work type, and the worker code of the worker to the server device 130. It is noted that it is assumed that the worker code is stored in the memory 102 of the smart glasses 100 in advance. Further, as another example, at the start of the work, the worker may cause the smart glasses 100 to read a bar code indicating a worker code, and store the worker code corresponding to the bar code read by the smart glasses 100 in the memory 102. Here, the product code is an example of item information relating to a product (item) to be worked on. Further, the process of S803 is an example of an acquisition process of acquiring item information.

When the CPU 131 of the server device 130 receives the work type, the product code, and the worker code in S803, the processing proceeds to S804. In S804, the CPU 131 refers to the product table 400 (FIG. 4) to identify instruction information corresponding to the product code and the work type. Further, the CPU 131 refers to the worker table 600 (FIG. 6) to identify a skill level from the worker code. Then, the CPU 131 refers to the attention table 500 (FIG. 5) to determine whether or not there is information that satisfies the conditions of the product code, the work type, and the skill level. If attention information that satisfies the conditions is stored therein, the CPU 131 identifies the attention information, a period and an output timing. It is noted that the attention information is determined according to the product code, the work type, and the skill level serving as a worker attribute, and the process of S804 is an example of a decision process of deciding attention information based on a product (item).

Next, in S805, the CPU 131 transmits the instruction information and the attention information to the smart glasses 100. At this time, the CPU 131 transmits the period and output timing associated with the attention information together with the attention information.

When the CPU 101 of the smart glasses 100 receives the instruction information and the attention information in S805, the processing proceeds to S806. In S806, the CPU 101 performs control of displaying the instruction information on the display 105. Next, in S807, the CPU 101 refers to the period and the output timing, and displays the attention information at an appropriate timing. For example, with a product code of “M001” and a work type of “deliver”, a period of “unlimited”, and an output timing of “at start of work” are associated. Therefore, in this case, control is performed in which the attention information is displayed immediately after the reception of the attention information. It is noted that, if they are associated with an output timing of “at end of work”, the CPU 101, when receiving an utterance of “OK! Picking completed” from the worker via the microphone 120, determines that it is “at end of work”, and displays the attention information at that timing. Further, the smart glasses 100 may receive an utterance such as “OK! Arrived” or “OK! Start work!” and determine the output timing based on such an utterance. The process of S807 is an example of an output control process of performing control of outputting attention information.

FIG. 10 is a diagram illustrating an example of a display screen displayed on the display 105 by the smart glasses 100 in S806. On a display screen 1000, instruction information of “Please pick the following items” is displayed, and information on the product is also displayed. FIG. 11 is a diagram illustrating an example of a display screen displayed on the display 105 by the smart glasses 100 in S807. On a display screen 1100, attention information of “Please pick both body and lid” is displayed. In this way, the smart glasses 100 can perform control of outputting, at an appropriate timing, attention information for calling attention to the worker during work. It is noted that, if no attention information that satisfies the conditions is stored in S804, the server device 130 does not transmit the attention information. Accordingly, the display of the attention information in S807 in the smart glasses 100 is not performed, and the processing proceeds to S808 after the process of S806.

Returning to FIG. 8, after the process of S807, in S808, the CPU 101 of the smart glasses 100 determines whether or not location information has been acquired. When a two-dimensional code is included in a captured image acquired from the camera 110 and location information is read from the two-dimensional code, the CPU 101 determines that the location information has been acquired. Here, the location information is an example of position information relating to a position of a worker.

When the CPU 101 acquires the location information (Yes in S808), the processing proceeds to S809. If the CPU 101 fails to acquire location information (No in S808), the processing proceeds to S813. In S809, the CPU 101 transmits the location information to the server device 130.

When the server device 130 receives the location information in S809, the processing proceeds to S810. In S810, the CPU 131 of the server device 130 refers to the location table 700 to determines whether or not the received location information satisfies the conditions stored in the location table 700. If the location information satisfies the conditions, the CPU 131 identifies the corresponding attention information. Next, in S811, the CPU 131 transmits the identified attention information to the smart glasses 100. When the smart glasses 100 receive the attention information in S811, the processing proceeds to S812. In S812, the CPU 101 performs control of displaying the attention information.

It is noted that, in S810, if the received location information is not stored in the location table 700, that is, if the location information does not satisfy the conditions for the location information, the CPU 131 does not transmit attention information. Accordingly, the display of the attention information in S812 in the smart glasses 100 is not performed, and the processing proceeds to S813 after the process of S811.

Further, as another example, a time limit and an output timing for the attention information may also be set in the location table 700. In this case, in S812, the CPU 101 controls the display of the attention information according to the corresponding time limit and output timing.

After the process of S812, in S813, the CPU 101 determines whether or not all the work indicated in the pick list has been completed. For example, when the work is completed, the worker utters “OK! Pick completed”, and the CPU 101, when receiving that utterance via the microphone 120, determines that all the work is completed. When all the work has been completed (Yes in S813), the CPU 101 ends the work management process. If there is any unprocessed work (No in S813), the processing proceeds to S802 to continue the processing in the CPU 101.

As described above, the information processing system according to the present embodiment can call attention about work at an appropriate timing with a simple configuration.

It is noted that, as a first modification of the present embodiment, the devices serving as the main components that perform the processes in the smart glasses 100 and the processes in the server device 130 described with reference to FIG. 8 are not limited to the embodiment. For example, in S800, the server device 130 generates and transmits a pick list in which instruction information, attention information, its period, output timing, and the like are described in the pick list. Then, the smart glasses 100 may display the instruction information and the attention information by referring to the information included in the acquired pick list without communicating with the server device 130 every time the attention information is output. Specifically, the CPU 101 of the smart glasses 100 identifies the instruction information based on the association between a product code and the instruction information indicated in the pick list. Similarly, the CPU 101 identifies the attention information based on the association between the product code and the attention information. Further, as another example, the smart glasses 100 may store the product table 400, the attention table 500, and the location table 700, and the smart glasses 100 may perform all the processes.

Further, as a second modification, in the present embodiment, when the output timings of a plurality of pieces of attention information overlap, the smart glasses 100 output all the pieces of attention information, but a piece of attention information may be output according to the priority instead of all output. For example, the server device 130 sets a priority for each piece of attention information. When transmitting attention information to the smart glasses 100, the server device 130 transmits the attention information together with the priority. Then, the smart glasses 100 outputs only a piece of attention information having the highest priority order of the pieces of attention information that are determined to be transmitted in a relatively short fixed period of time.

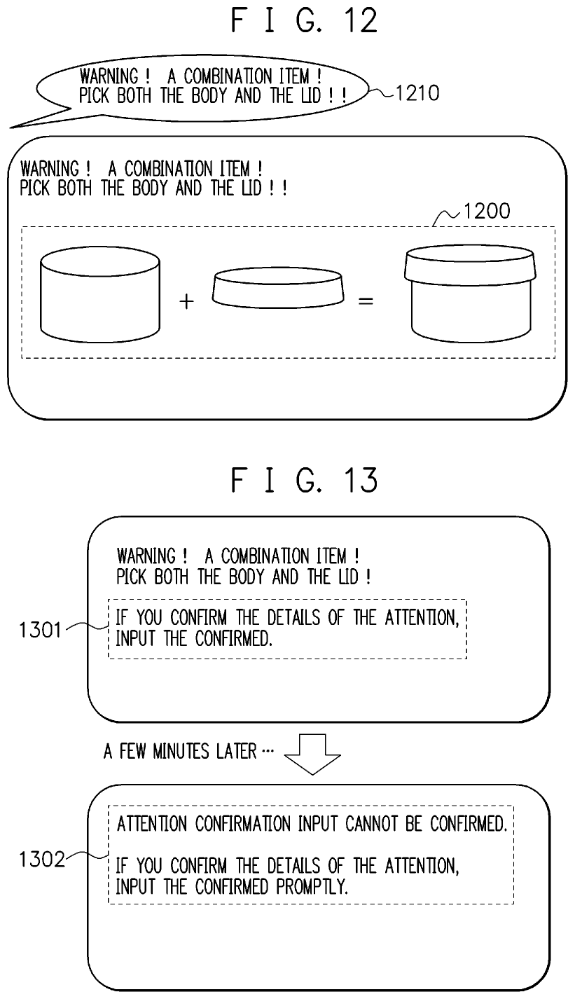

As a third modification, the output form of the attention information from the smart glasses 100 is not limited to the embodiment. As illustrated in FIG. 12, the smart glasses 100 may display not only the text information but also an image 1200 to urge the worker to call attention on the display 105. In addition, as another example, the smart glasses 100 may further include a speaker to output the attention information as a voice 1210 from the speaker.

As a fourth modification, after the smart glasses 100 output (display) the attention information, the smart glasses 100 may confirm that the worker has confirmed the attention information. For example, as illustrated in FIG. 13, the smart glasses 100 display information 1301 for prompting a confirmation input together with the attention information. Further, when not receiving the confirmation input for a fixed period of about several minutes thereafter, the smart glasses 100 display information 1302 for prompting the confirmation input again. It is noted that, after displaying the information 1301, the smart glasses 100 do not display the information 1302 when receiving the confirmation information indicating the confirmation.

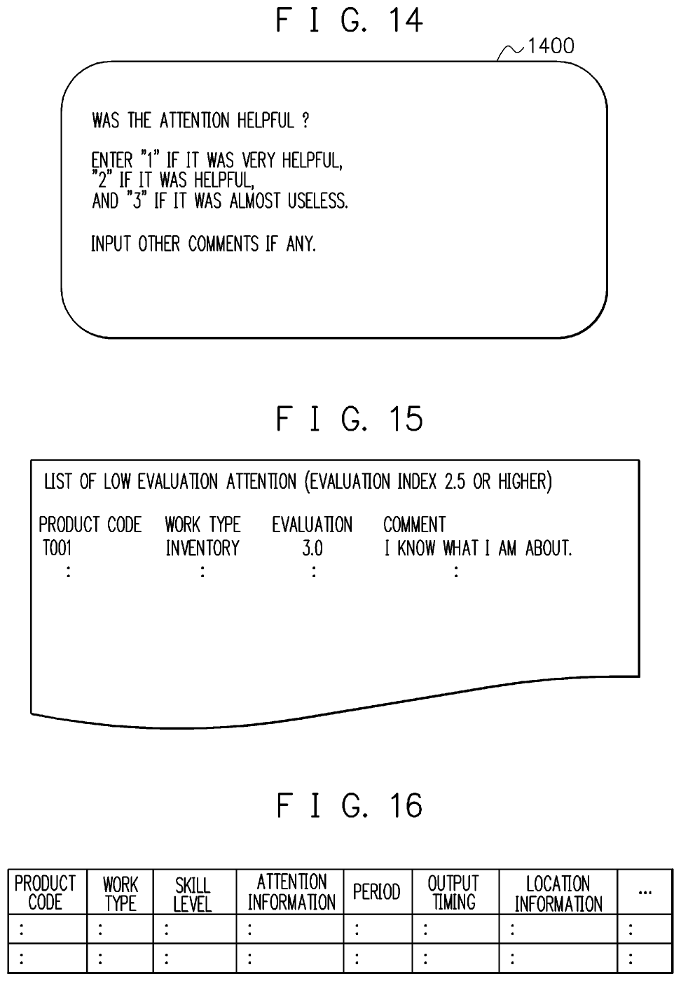

As a fifth modification, the smart glasses 100 may receive usefulness feedback indicating whether or not the attention through the display of the attention information has helped the worker. The smart glasses 100 display, for example, a confirmation screen 1400 as illustrated in FIG. 14. The confirmation screen 1400 displays information for prompting an evaluation input for the attention. In the present example, the worker can input the evaluation with numerical values of “1” to “3”. In response to this, the smart glasses 100 receive evaluation information indicating the evaluation result (reception process) and transmits the evaluation information to the server device 130. Then, the server device 130 aggregates the evaluation results and outputs the aggregation result. FIG. 15 is a diagram illustrating an output example of an evaluation result. Thus, a manager or the like can refer to the evaluation result when considering improvement of a work process.

As a sixth modification, for example, the smart glasses 100 may perform control of identifying process information indicating a work process and displaying attention information according to the work process. It is noted that, as a method of identifying the work process, for example, the process information may be identified by reading a two-dimensional code displayed on a component, a tool, or the like used only in the work process. Alternatively, a configuration may be provided in which, when a user starts work, information indicating a work process is input to the information processing system via an input device, so that the smart glasses 100 identify process information indicating the work process.

As a seventh modification, in the present embodiment, as described with reference to FIG. 8, the smart glasses 100 of the present embodiment perform a process to call attention about a position after performing a process to call attention about a product, but the order of processing is not limited to the embodiment. As another example, the smart glasses 100 may perform a process to call attention about a product after performing a process to call attention about a position. Specifically, the smart glasses 100 may perform the processes of S801 to S807 after the processes of S808 to S812 illustrated in FIG. 8. Further, when generating a pick list, the server device 130 may generate the pick list in a manner that the attention information for each piece of position information and the attention information for each product are included in the pink list. In this case, after receiving the pick list, the smart glasses 100 may present the worker the attention information based on the attention information included in the pick list without requesting confirmation to the server device 130.

As an eighth modification, the data configuration of various data (tables) stored in the smart glasses 100 is not limited to the embodiment. For example, FIG. 16 is an example of a table according to a modification. A table 1600 illustrated in FIG. 16 is a table in which the location table 700 is incorporated in the attention table 500 (FIG. 5) described in the embodiment.

For example, when outputting attention information corresponding to a work place, the smart glasses 100 refer to a location information field of the table illustrated in FIG. 16 based on the acquired information indicating the work place of the worker. Then, the smart glasses 100 may output the attention information in a record including the location information that matches the work place. Further, as another example, the smart glasses 100 may refer to the field for product code in the table illustrated in FIG. 16 based on acquired information on a product to be worked on, and output the attention information in a record including the product code that matches the product. Further, the smart glasses 100 may output the attention information based on information in a plurality of fields. For example, among the pieces of information included in the table illustrated in FIG. 16, the attention information in a record in which all of the product code, the work type, the location information, and the skill level corresponding to the acquired worker and the information relating to the worker are satisfied may be output.

### Other Embodiments

Further, the present invention is also realized by executing the following processing. That is, software (program) that realizes the functions of the above-described embodiments is supplied to a system or a device via a network or various recording media. A computer (or CPU, MPU, or the like) of the system or device reads out and executes the program, resulting in a process.

As described above, the preferred embodiments of the present invention are described in detail. However, the present invention is not limited to such specific embodiments, and various modifications and changes may be made without departing from the scope and spirit of the present invention defined in the claims.

1. An information processing system, comprising
an output controller configured to perform control of outputting attention information for calling attention to a worker when a predetermined condition determined in advance for work is satisfied.

2. The information processing system according to claim 1, wherein
the output controller performs control of outputting the attention information to a display unit of a wearable device worn by the worker.

3. The information processing system according to claim 1, further comprising:
an acquirer configured to acquire information; and
a determiner configured to determine whether the condition is satisfied based the information.

4. The information processing system according to claim 3, wherein
the acquirer acquires the information from an image captured by an image capturing unit of a wearable device worn by the worker.

5. The information processing system according to claim 3, wherein
the condition is a condition relating to a type of the work,
the acquirer acquires information indicating a type of work of the worker, and
the determiner determines whether the condition is satisfied, based on information indicating the type of work acquired by the acquirer.

6. The information processing system according to claim 5, further comprising
a decider configured to decide the attention information based on the information indicating the type of work,
wherein the output controller performs control of outputting the attention information decided by the decider.

7. The information processing system according to claim 3, wherein
the condition is a condition relating to a work place of the work,
the acquirer acquires position information relating to a work place of the worker, and
the determiner determines whether the condition is satisfied, based on the position information acquired by the acquirer.

8. The information processing system according to claim 7, further comprising
a decider configured to decide the attention information based on the position information,
wherein the output controller performs control of outputting the attention information decided, by the decider.

9. The information processing system according to claim 3, wherein
the condition is a condition relating to an item relating to the work,
the acquirer acquires item information relating to an item to be worked on by the worker, and
the determiner determines whether the condition is satisfied, based on the item information acquired by the acquirer.

10. The information processing system according to claim 9, further comprising
a decider configured to decide the attention information based on the item information,
wherein the output controller performs control of outputting the attention information decided by the decider.

11. The information processing system according to claim 1, wherein
the condition is a condition relating to a period, and
the output controller performs control of outputting the attention information when a timing of performing work satisfies the condition relating to the period.

12. The information processing system according to claim 1, further comprising:
an acquirer configured to acquire an attribute of the worker; and
a decider configured to decide the attention information based on the attribute,
wherein the output controller performs control of outputting the attention information decided by the decider.

13. The information processing system according to claim 1, further comprising
a receiver configured to receive confirmation information indicating that the attention information has been confirmed.

14. The information processing system according to claim 1, comprising:
a receiver configured to receive evaluation information from the worker for an output of the attention information; and
an aggregator configured to aggregate the evaluation information.

15. An information processing device comprising
an output controller configured to perform control of outputting attention information for calling attention to a worker when a predetermined condition determined in advance for work is satisfied.

16. An information processing method executed by an information processing system, the information processing method comprising
an output control step of performing control of outputting attention information for calling attention to a worker when a predetermined condition determined in advance for work is satisfied.

17. (canceled)

18. A non-transitory computer-readable recording medium recording a program for causing a computer to function as
an output controller configured to perform control of outputting attention information for calling attention to a worker when a predetermined condition determined in advance for work is satisfied.
